(19) United States
(12) Patent Application Publication
(10) Pub. No.: US 2007/0113709 A1
(43) Pub. Date: May 24, 2007

(54) DEADBLOW HAMMER

(76) Inventor: Anthony Krallman, City of Industry, CA (US)

Correspondence Address: CHRISTIE, PARKER & HALE, LLP, PO BOX 7068, PASADENA, CA, 91109-7068, US

(21) Appl. No.: 11/627,823

(22) Filed: Jan. 26, 2007

Related U.S. Application Data
(63) Continuation-in-part of application No. 11/595,534, filed on Nov. 9, 2006.
Application No. 11/595,534 is a continuation of application No. 11/106,226, filed on Apr. 14, 2005, now abandoned.
Application No. 11/106,226 is a continuation of application No. 10/246,867, filed on Sep. 17, 2002, now Pat. No. 6,904,829.

(51) Int. Cl. B25D 1/12; B25D 1/00

(52) U.S. Cl. 81/22

(57) ABSTRACT

Deadblow hammers capable of minimizing or eliminating recoils when the hammers impact their targets are discussed. These hammers have easy access anti-recoil chambers, at least one insert element placed inside the anti-recoil chamber, and improved openings for inserting the insert element. The insert element or elements function to negate the effects of the hammer recoils. Golf clubs with anti-recoil chamber and insert elements are also discussed.

### CROSS-REFERENCE TO RELATED APPLICATIONS

This is a continuation-in-part application of Ser. No. 11/595,534, filed Nov. 9, 2006, entitled Deadblow Hammer, which is a continuation application of Ser. No. 11/106,226, filed Apr. 13, 2005, entitled Deadblow Hammer, now U.S. Pat. No. 7,134,363, which is a continuation of Ser. No. 10/246,867, filed Sep. 17, 2002, entitled Deadblow Hammer, now U.S. Pat. No. 6,904,829, the contents of each of which are expressly incorporated herein by reference.

### FIELD OF ART

Deadblow hammers capable of minimizing or eliminating recoils when the hammers impact their targets are discussed herein. These hammers incorporate one or more insert elements, which function to negate the effects of the hammer recoils.

### BACKGROUND

It is a well-known principle that every action has an equal and opposite reaction (Newton's Third Law). Thus, for a hammer, when the impact surface of the hammer head impacts a target, the hammer is jolted backwards due to the reaction caused by the hammer head striking its target. This opposite reaction is commonly referred to as hammer recoil.

For minimizing or eliminating hammer recoils, which cause vibrations and injuries to the user, numerous hammers were invented. Broadly speaking, these hammers utilize some form of inserts placed in a hollow chamber within the hammer head, or within a separate hollow body having a hollow chamber attached to the hammer head. The inserts are configured to move from a rear surface of the hollow chamber to a front surface of the hollow chamber. Accordingly, when the hammer moves in a first direction to impact its target, the inserts are pushed by the rear surface of the hollow chamber to move in the same first direction.

As the impact surface of the hammer head impacts a target and starts its recoil in a second direction, the inserts still move in the first direction within the hollow chamber and impact the front surface of the hollow chamber, in the first direction. The inserts impacting against the front surface of the hollow chamber thus cancel the recoil in total or substantially. The amount of cancellation depends, in part, on the weight percentage of the inserts compared to the weight of the hammer head. Without being restricted to any particular theory, the deadblow impact or feel to the user also depends on the distance the insert travels before it impacts the front surface, which will influence how far the hammer recoils before the insert impacts the front surface to cancel out the effect.

U.S. Pat. No. 6,234,048 to Carmien discloses a non-recoil hammer, with a hammer head that has an open socket for receiving a separate hollow canister. The hollow canister connects to a tool handle and contains a relatively high mass moveable filler material in a hollow chamber, such as steel shot pellets. The hollow canister is received within the open socket to form a completed hammer. Due to the two-piece design, the hammer is more complicated and costly to manufacture.

U.S. Pat. No. 5,916,338 to Bergkvist et al. discloses a hammer having a hammer head with an impact element and a cavity at least partially filled with particulate material, such as steel shot, so as to dampen the recoil of the hammer. The impact element is forged with the head as a single piece or may be formed as a separate part that is connected to the head by welding. However, since the cavity extends the full length of the hammer head, the handle cannot attach to the hammer head by passing through a central portion of the hammer head, but is attached via a partial through hole at the central portion of the hammer head. This makes the handle more susceptible to slippage or separation from the hammer head. Furthermore, because of the cavity, a conventional handle with a split end for wedging the handle with a wedge is not useable with the disclosed hammer head.

U.S. Pat. No. 4,039,012 to Cook discloses a non-rebound hammer having a hammer head portion with forwardly and rearwardly facing metallic impact surfaces. The head portion contains a hollow cylindrical core for receiving a quantity of pellets, such as small lead shots. The hammer head also contains a core hole for receiving a handle rod. The handle rod and the hammer head are then co-molded with an encasement. Due to the co-molded configuration, the entire hammer must be discarded when damage is done to the handle.

U.S. Pat. No. 2,604,914 to Kahlen discloses a hammer head having a rebound-preventing means. The hammer head has a body with a striking head at each end of the body. Each striking head is formed integrally with the body, or alternatively it may be secured to the body as a separate piece. A chamber is formed in the body immediately behind the striking heads. The chamber contains irregularly shaped particles 26, as shown in FIG. 3 of the '914 patent. The particles almost completely fill the chamber, with the total weight of the particles dependent on the recoil quality of the striking head, the size of the hammer, and the weight of the head. Due to the lengthwise chamber, a ferrule is used to connect a handle to the body. This makes the body unnecessarily bulky.

There is therefore a need for a non-recoil hammer or deadblow hammer that minimizes or negates the effects of hammer recoils and that do so without the shortcomings of prior art deadblow hammers. Additionally, there is also a need for a method of making the desired deadblow hammer.

### SUMMARY

The present invention specifically addresses and alleviates the above-mentioned deficiencies associated with the prior art anti-recoil hammers. More particularly, the present invention comprises a deadblow hammer comprising a hammer head having a body, an anti-recoil chamber for receiving a plurality of insert elements located within a section of the body, and an open socket defined by a handle chamber which passes through the body for receiving a handle. The anti-recoil chamber comprises a first opening that is in communication with the open socket and that provides a first passage into the anti-recoil chamber, the first opening allowing the plurality of insert elements to be placed into the anti-recoil chamber by way of the open socket; and wherein insertion of the handle into the handle chamber seals off the first opening and occupies the open socket. Together, these features define a deadblow hammer that is more economical to make and that has an anti-recoil chamber that is easy to access.

The present invention also involves a deadblow hammer comprising a hammer head having a body, two anti-recoil chambers, each having a plurality of insert elements situated therein and an impact surface attached adjacent thereto, and an open socket defined by a handle chamber that passes through the body for receiving a handle. This hammer is commonly known in the art as a sledge hammer.

The two anti-recoil chambers in the sledge hammer each comprise a first opening that is in communication with the open socket and that provides a first passage into the anti-recoil chamber from the open socket; the first opening allows the plurality of insert elements to be placed into the anti-recoil chamber by way of the open socket; and wherein an insertion of the handle into the handle chamber seals off the first opening of each of the anti-recoil chamber and causes the open socket to be occupied.

The present invention also involves a golf club head comprising a club face, a hosel for attaching the club head to a shaft, and a hollow chamber disposed within the club head; and wherein the hollow chamber includes insert elements for negating and dampening recoils when the golf club head impacts a solid surface.

In another embodiment, a deadblow hammer comprises a hammer head comprising a body section having an interior surface defining an anti-recoil chamber having an internal cross-sectional dimension, the hammer head further comprising a handle chamber, an impact surface, a front wall disposed opposite the impact surface, and at least one of a back wall opposite the front wall and an opening in communication with the handle chamber. The hammer also includes a handle attached to the handle chamber. An insert element is disposed within the anti-recoil chamber and contacts the interior surface of the body section. The insert element has a width that is about 50 percent to about 95 percent of the internal cross-sectional dimension of the anti-recoil chamber and is movable within the anti-recoil chamber and contacts both the front wall and at least one of the back wall and the handle.

In yet another embodiment, a deadblow hammer comprises a hammer head comprising an impact surface and a body section having an interior surface defining an anti-recoil chamber having an internal width, the interior surface having an opening. A handle is attached to the hammer head. An insert element is placed in the anti-recoil chamber by way of the opening, the insert element having a width that is greater than half the internal width of the anti-recoil chamber. The insert element is movable within the anti-recoil chamber and contacts the interior surface of the body section. The opening is adapted to be closed after placement of the insert element. The anti-recoil chamber is defined by a front wall disposed opposite the impact surface, the interior surface of the body section, and at least one of a portion of the handle and a back wall opposite the front wall. The insert element is adapted to contact at least one of the portion of the handle and the back wall when the hammer is swung forward.

In still another embodiment, a deadblow hammer comprises a hammer head comprising an anti-recoil chamber having an internal cross-sectional dimension, the hammer head further comprising a handle chamber, an impact surface, a front wall disposed opposite the impact surface, and at least one of a back wall opposing the front wall and an opening in communication with the handle chamber. The hammer also includes a handle attached to the handle chamber. An insert element is disposed within the anti-recoil chamber. The insert element has a width that is about 50 percent to about 95 percent of the internal cross-sectional dimension of the anti-recoil chamber and is rotatable and translatable within the anti-recoil chamber. The insert element contacts both the front wall and at least one of the back wall and the handle.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a semi-schematic perspective view of an exemplary deadblow hammer provided in accordance with practice of the present invention;

FIG. 2 is a semi-schematic cross-sectional side view of the deadblow hammer of FIG. 1;

FIG. 2A is a semi-schematic cross-sectional view of the deadblow hammer of FIG. 1 with a v-groove;

FIG. 3 is a semi-schematic cross-sectional side view of the hammer of FIG. 2 with an alternative anti-recoil chamber;

FIG. 4 is a semi-schematic cross-sectional side view of the hammer of FIG. 2 with another alternative anti-recoil chamber;

FIG. 5 is a semi-schematic cross-sectional side view of the hammer of FIG. 2 with yet another alternative anti-recoil chamber;

FIG. 5a is a semi-schematic cross-sectional side view of the hammer of FIG. 2 with side openings;

FIG. 6 is a semi-schematic top plan view of the hammer head of FIG. 1;

FIG. 7 is a semi-schematic end view of the hammer head of FIG. 2 taken at line A-A;

FIG. 8 is a semi-schematic end view of the impact plate provided in accordance with practice of the present invention;

FIG. 9 is a semi-schematic cross-sectional view of the impact plate of FIG. 8 taken at line B-B;

FIG. 10 is a semi-schematic cross-sectional view of an alternative hammer head provided in accordance with practice of the present invention;

FIG. 11 is a manufacturing flow diagram provided in accordance with practice of the present invention;

FIG. 12 is a metal golf club having an anti-recoil chamber provided in accordance with practice of the present invention;

FIG. 13 is a metal wood golf club having an anti-recoil chamber made from a tube provided in accordance with practice of the present invention;

FIG. 14a is a semi-schematic cross-sectional side view of an exemplary deadblow hammer provided in accordance with practice of the present invention;

FIG. 14b is a semi-schematic cross-sectional side view of another embodiment of the deadblow hammer of FIG. 14a;

FIG. 15a is a semi-schematic cross-sectional side view of an exemplary hammer head provided in accordance with practice of the present invention;

FIG. 15b is a semi-schematic side view of another embodiment of the hammer head of FIG. 15a;

FIG. 16 is a semi-schematic cross-sectional view of an alternative hammer head provided in accordance with practice of the present invention;

FIG. 17 is a semi-schematic cross-sectional side view of an exemplary deadblow hammer provided in accordance with practice of the present invention;

FIG. 18a is a semi-schematic cross-sectional side view of an exemplary hammer head provided in accordance with practice of the present invention;

FIG. 18b is a semi-schematic cross-sectional side view of another embodiment of the hammer head of FIG. 18a; and

FIG. 19 is a semi-schematic cross-sectional side view of an exemplary hammer head provided in accordance with practice of the present invention.

### DETAILED DESCRIPTION

The detailed description set forth below in connection with the appended drawings is intended as a description of the presently preferred embodiments of the deadblow hammer in accordance with the present invention and is not intended to represent the only forms in which the present invention may be constructed or utilized. The description sets forth the features and the steps for constructing and using the deadblow hammer of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

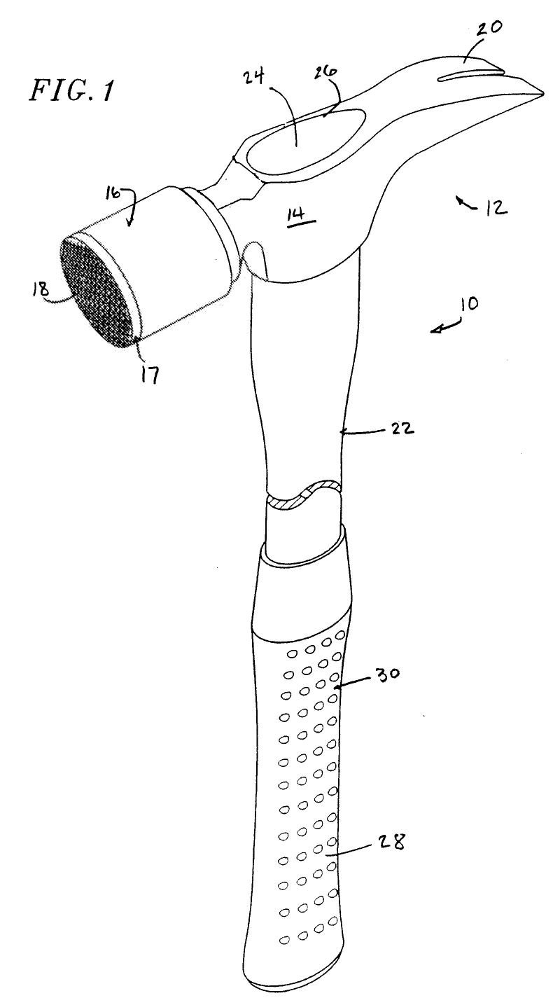

Referring now to FIG. 1, there is shown a deadblow hammer (“hammer”) provided in accordance with practice of the present invention, which is generally designated 10. The hammer 10 comprises a hammer head 12, which includes a body 14, an impact section 16, an impact plate 17 having an impact surface 18 and a claw 20. The hammer 10 further comprises a handle 22, which includes an attachment portion 24 for attaching to the open socket 26 of the hammer head 12 and a handle portion 28 for facilitating gripping of the hammer 10. The handle 22 is shown with an optional handle grip 30, which may be made from a rubber material and slidably inserted over the handle portion 28 of the handle 22.

The hammer head 10 is preferably cast from a steel material but alternatively may be forged from a steel block. The handle 22 may be any number of conventional handles, including handles made from wood, plastic, and fiberglass.

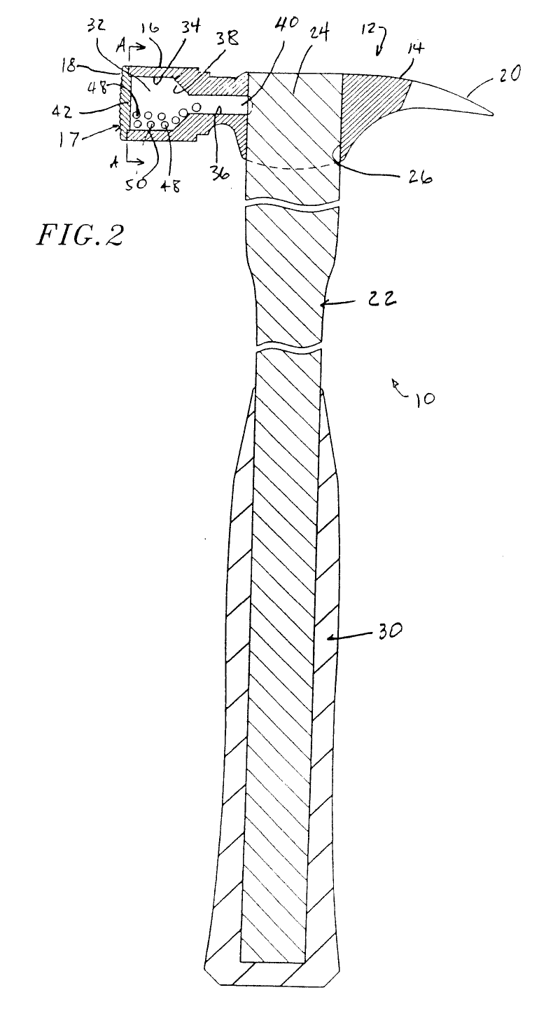

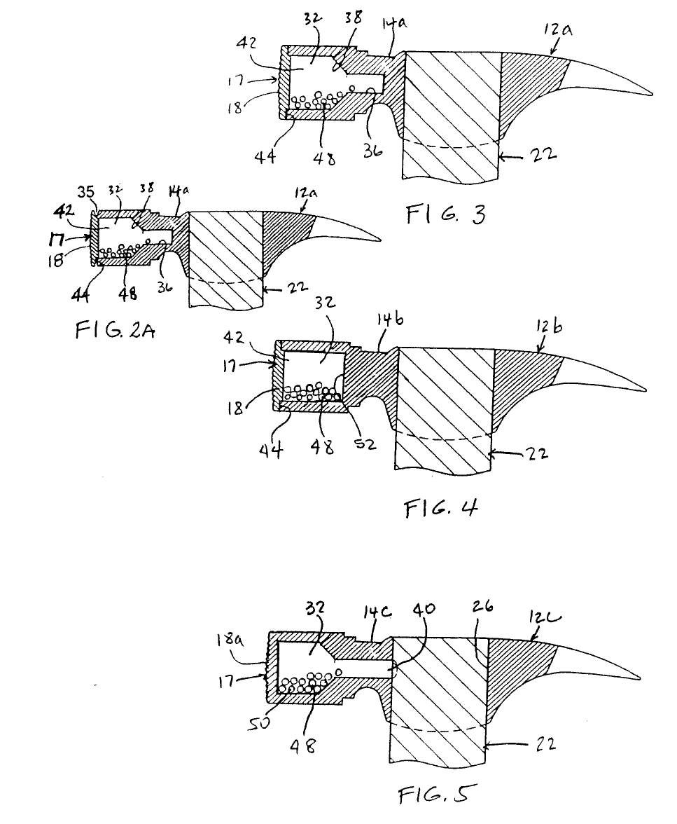

Referring now to FIG. 2, there is shown a semi-schematic cross-sectional view of the hammer 10 of FIG. 1. As shown, the hammer head 12 comprises a hollow chamber 32, which is also referred to herein as an anti-recoil chamber. The hollow chamber 32 comprises an enlarged chamber section 34, a relatively smaller tail chamber section 36, and a tapered transitional section 38. The tapered transitional section 38 may include a straight taper, as shown, or a curved taper. The hollow chamber 32 further includes a first opening 40 that is just proximal of the tail chamber section 36. The first opening 40 opens into the open socket 26 and is in communication with the open socket. However, once the handle 22 is inserted into the open socket 26, the communication is severed and the attachment portion 24 of the handle occupies the open socket (FIG. 2). Although the open socket 26 is shown with a straight wall, it is understood that a tapered wall may be incorporated without deviating from the scope of the present invention.

A separate impact plate 17 is shown attached to the body 14 of the hammer head 12 and covers the hollow chamber's second opening 42. The second opening 42 is shown larger than the first opening 40. However, the arrangement is merely a designer's choice as the relative dimensions between the first opening 40 and the second opening 42 may be reversed. The impact plate 17 may be attached to the body 14 by conventional welding methods, by threads, or by inertia welding. In inertia welding, the body 14 is held in a lath and spins at relatively high speed. The lath used for inertia welding can be a vertical standing lath or a horizontal lath. The impact plate 17, which is not spinning, is then pushed against the spinning end surface 44 of the second opening 42. The friction generated by the contact causes the impact plate 17 and the end surface 44 to partially melt, which results in their fusion. As a by-product of their impact, a protruding section 46 is formed on the impact plate 17, which protrudes into the hollow chamber 32. Alternatively, the impact plate 17 can be rotated in the lath and the body 14 held stationary.

A plurality of insert elements 48 are shown placed in the hollow chamber 32. The insert elements 48 can be any number of weighted materials such as spherical pellets, small metal scraps, lead shots, or their equivalence. In one embodiment, steel pellets 50 are used for the insert elements 48. The quantity of steel pellets 50 used is approximately equal to 25% to 70% of the weight of the hammer head 12 with 30% to 60% being more preferred. In another embodiment, tungsten shots are used for their relatively heavier density than steel. Consequently, less space or volume is required for the same weight percentage when tungsten shots are used.

The insert elements 48 are added to the hollow chamber 32 by individually depositing the steel pellets 50 in through the first opening 40, before attaching the handle 22 into the open socket 26 and after attaching the impact plate 17 to the end surface 44. Alternatively, the steel pellets 50 may be added to the hollow chamber by first magnetizing the pellets or gluing the pellets so that they form a single large mass. The single large mass can then be added to the hollow chamber via the second opening 42, before attaching the impact plate 17 to the end surface 44. Subsequently, the impact plate 17 may be attached to the end surface 44 by inertia welding, using a vertical standing lath, or by conventional welding. Due to the size of the single large mass, it will not fall out of or fall through the first opening 40 when the welding is taking place. It is understood that if conventional welding is utilized to attach the impact plate 17 to the end surface 44, the surfaces to be welded should be chamfered to provide a v-groove 35 for welding, See, e.g., FIG. 2A.

Turning now to FIG. 3, there is shown an alternative hammer head 12a provided in accordance with practice of the present invention. The hammer head includes a single large opening 42 leading into the hollow chamber 32. The smaller opening has been eliminated from the hammer head 12 shown in FIG. 2, but the tail chamber section 36 and the tapered transitional section 38 still incorporated. The hammer head 12a may be made by casting or forging the body 14a separately from the impact plate 17. The insert elements 48 may be added to the hollow chamber 32 and the impact plate 17 welded to the end surface 44 of the body 14a in the same fashion as discussed above with reference to FIG. 2.

Turning now to FIG. 4, there is shown another alternative hammer head 12b provided in accordance with practice of the present invention. The hammer head 12b includes a single large opening 42 leading into the hollow chamber 32. The hollow chamber 32 is preferably cylindrical but may take on other or additional contours, such as a slight taper from the large opening 42 towards the back wall 52 of the hollow chamber. The hammer head 12b may be made by casting or forging the body 14b separately from the impact plate 17. The insert elements 48 may be added to the hollow chamber 32 and the impact plate 17 welded to the end surface 44 of the body 14b in the same fashion as discussed above with reference to FIG. 2.

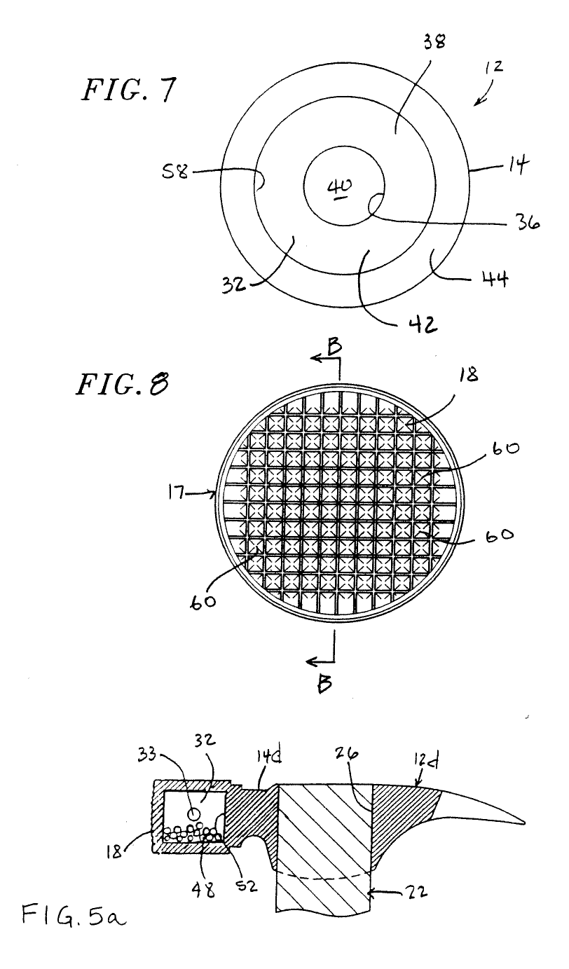

Turning now to FIG. 5, there is shown yet another alternative hammer head 12c provided in accordance with practice of the present invention. The hammer head 12c includes a single small opening 40 that leads into the hollow chamber 32, as shown in FIG. 2. However, the impact plate 17 is now integrally formed with the body 14c. The hammer head 14c is therefore made from casting only, as further discussed below. The insert elements 48 may be added to the hollow chamber 32 by adding the individual pellets in through the small opening 40 before inserting the handle 22 into the open socket 26, as discussed above with reference to FIG. 2.

FIG. 5a shows still yet another alternative hammer head 12d provided in accordance with practice of the present invention. Similar to the other embodiments (i.e., FIGS. 1-5), the present embodiment preferably includes two openings 33, one on each of the left and right side surface of the hammer head body 14d and each being in communication with the hollow chamber 32. The impact surface 18 is integrally cast with the body 14d and the open socket 26 extends through the body without an opening, like the embodiment of FIG. 5. Thus, the insert elements 48 are added to the hollow chamber 32 via the side openings 33 and then subsequently sealed by plugs or caps. Alternatively, the openings 33 may be located along the upper and lower side surfaces of the hammer head body 14d, and may take on 1 or more than 2 openings. The present embodiment, as well as other embodiments disclosed elsewhere herein, allows a conventional handle with a split attachment portion 24 to be used as it permits a wedge or several wedges to be inserted into the split attachment portion from the top of the open socket to wedge-in or lock-in the handle.

FIG. 6 is a top plan view of the hammer head 12 of FIGS. 1-5. Although shown with the particular impact plate 17, impact section 16, open socket, and claw 20, it is understood that the hammer head 12 may vary in any of these features, and in addition, in length, width, tapered neck section 54, stepped collar section 56 (located in between the impact section 16 and the tapered neck section), etc. without deviating from the scope the present invention. For example, the present invention may be practiced by varying the metallurgy, the overall hammer head weight, and replacing the claw 20 with another impact section, as further discussed below.

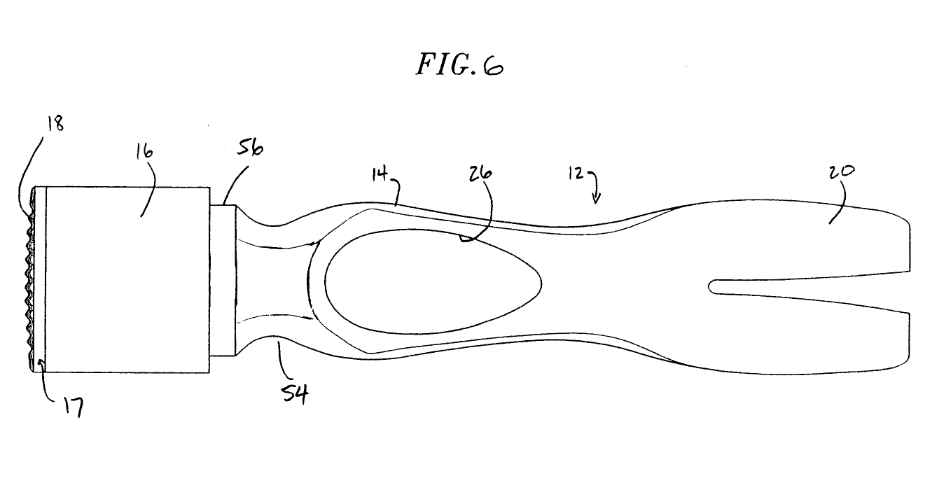

FIG. 7 is an end view of the hammer head 12 of FIG. 2 taken at line A-A. As shown, the large opening 42 opens into the hollow chamber 32, which has a circular chamber surface 58. The circular chamber surface 58 intersects the transitional section 38, which connects to the tail chamber section 36, which terminates into the small opening 40.

FIG. 8 is an end view of the impact plate 17 provided in accordance with practice of the present invention. The impact plate 17 includes an impact surface 18 having an array of bumps or serrations 60, which may be formed from casting, forging, or machining from bar stocks. However, a smooth surface or a dispersed array of bumps may be used instead of the serrated impact surface 18.

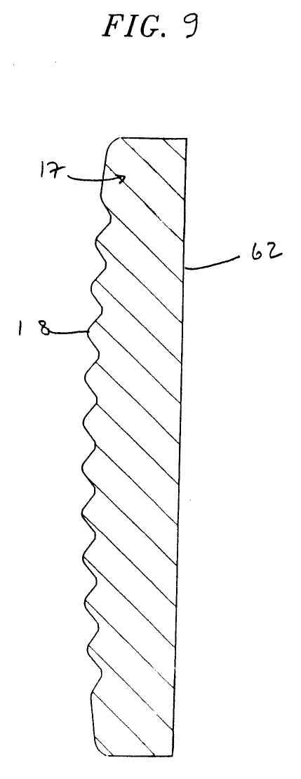

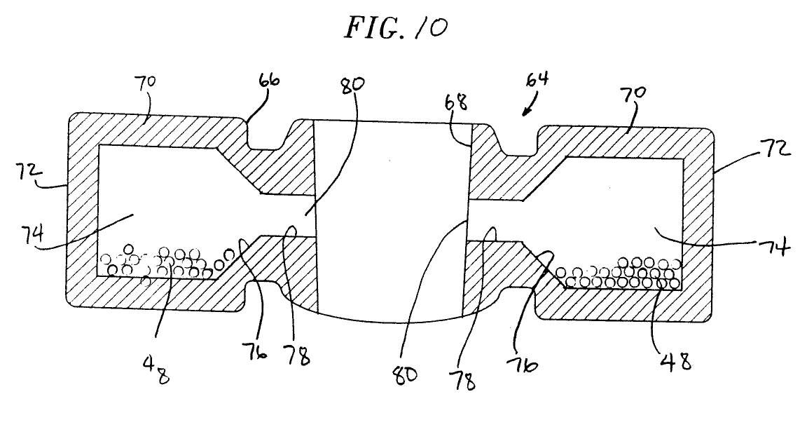

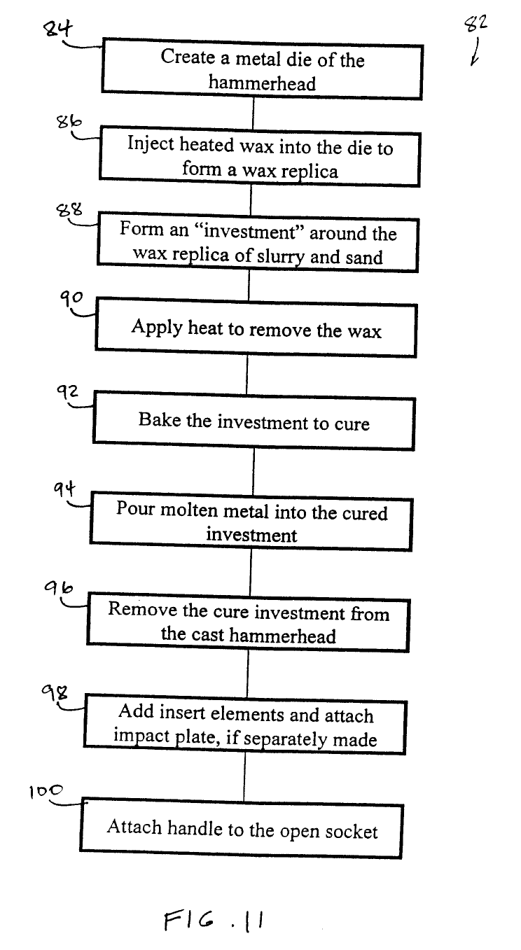

FIG. 9 is a semi-schematic cross-sectional view of the impact plate 17 of FIG. 8 taken at line B-B. As evident by FIG. 9, a neck or stepped surface on the rear surface 62 of the impact plate 17 is not necessary as a protruding section 46 will form as a by-product of the inertia welding (See, e.g., FIG. 2).

FIG. 10 shows an alternative hammer head provided in accordance with practice of the present invention, which is generally designated 64. The hammer head 64 is commonly found in a sledge hammer. In particular, the hammer head 64 comprises a body 66, a central open socket 68 (which is shown with a tapered surface but may include a straight surface), and two impact sections 70 with integrally molded impact surfaces 72. The hammer head 64 further includes two hollow chambers 74, one in each of the impact sections 70. Each hollow chamber 74 includes a tapered transition section 76 that leads to a tail chamber section 78 and that leads to an opening 80. As previously discussed with reference to, for example, FIGS. 1, 2, and 5, the insert elements 48 may be added to each of the hollow chambers 74 by way of the small opening 80, and preferably in equal amount. As before, the total insert elements should range from about 25% to 70% of the weight of the hammer head 64, with about 30% to 60% of the total weight being more preferred.

Although the hammer head 64 is shown with integrally formed impact surfaces 72, separate impact plates may be used and thereafter welded to the body 66, as previously discussed with reference to FIGS. 2-4. If separate impact plates are used, the small openings 80 may be eliminated from the hammer head 64, such as that shown in FIGS. 3 and 4.

FIG. 11 is a block flow diagram 82 of an exemplary manufacturing method provided in accordance with practice of the present invention. As shown, the method includes creating a metal die for the hammer head 84. The metal die for the hammer head can take on any number of configurations, including a hammer head with a single opening, an integral impact surface, a sledge hammer head, a finishing hammer head, or a framing hammer head, just to name a few.

Next, melted wax is pour into the die to create a wax replica of the hammer head 86. The wax is then dipped into a slurry bath comprising silica flour and a chemical binder to form an “investment” 88. After the investment hardens, the wax is removed from the investment by heating the investment and the wax in an oven or a steam chamber 90 to melt the wax. Once the wax is removed, the investment is baked or fired in a heater 92 to cure. Molten metal is then poured into the cured investment 94 to form the cast hammer head.

Once the cast hammer head sufficiently cools, the investment is removed 96 by impacting the hammer head to break up the investment. The hammer head is now ready to receive the insert elements 98. As discussed above with reference to FIGS. 2-5, if the impact plate is separately produced, the impact plate is then attached to the hammer head via welding. A handle is then attached to the hammer head 100 to complete the deadblow hammer.

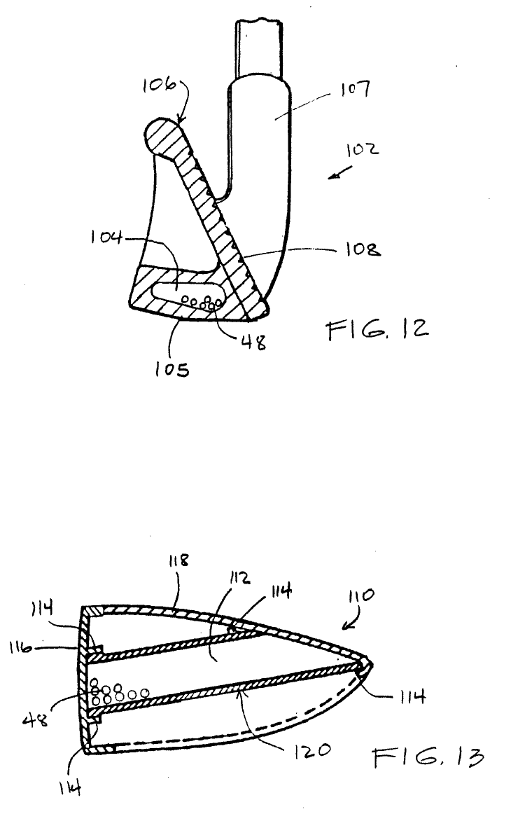

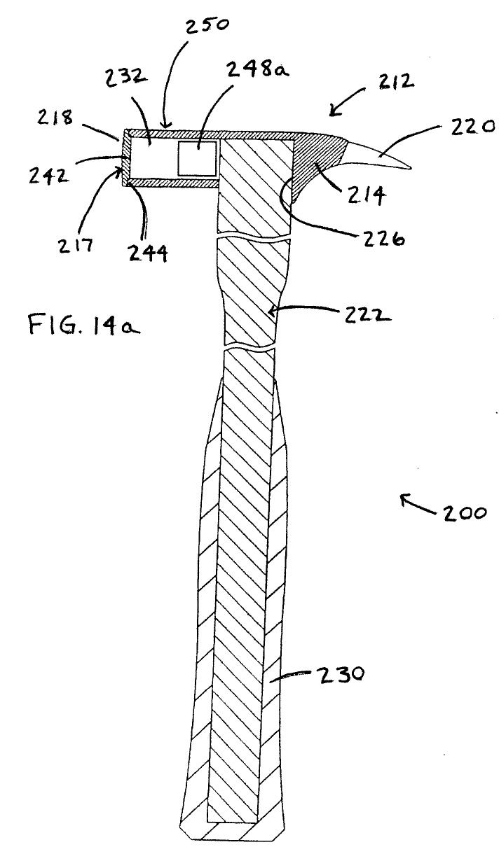

FIG. 12 depicts a metal golf club 102 that incorporates a hollow chamber 104 for receiving insert elements 48. The golf club head 106 is preferably cast so that the hollow chamber 104 may be formed into the sole 105 of the club head during fabrication. The hosel 107 shown can be any prior art hosel, including an offset hosel or a more conventional hosel for attaching to a shaft. The hollow chamber 104 preferably runs the width of the club face 108 (the direction that is perpendicular to the viewing plane) and is sealed by a cap (not shown). The cap can be attached to the club head 106 by welding. In an exemplary embodiment, steel pellets making up about 10% to 50% of the club head 10 are used to dampen the vibration and the recoil effects of the club head 106 as the club face 108 miss hits and strikes the ground. Exemplary metal golf clubs are disclosed in U.S. Pat. No. 6,344,000, which is incorporated herein by reference.

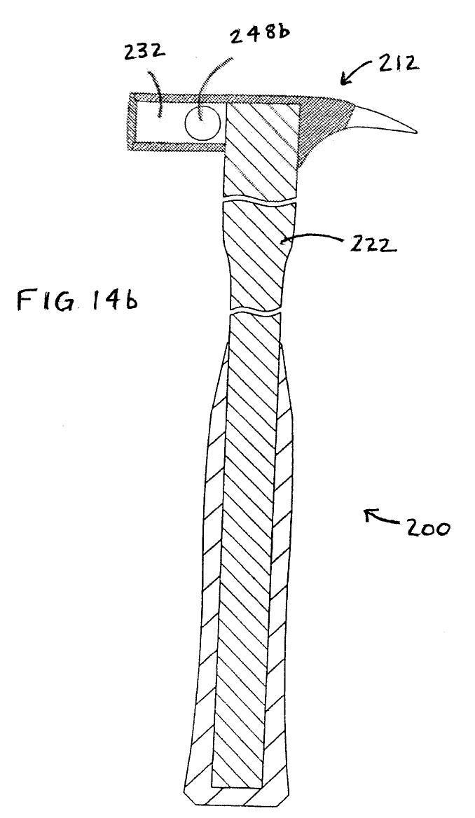

FIG. 13 depicts a metal wood golf head 110 that incorporates a hollow chamber 112 for receiving insert elements 48. The hollow chamber is formed by attaching retaining clips 114 to the club face 116 and to the shell 118 and connecting a hollow tube 120 thereinbetween. Although a hosel is not shown, it is understood that any prior art hosel may be incorporated into the golf club head 110 for attaching to a shaft. Similar to the golf club head of FIG. 12, the insert elements 48 preferably make up about 10% to about 50% of the weight of the metal wood 110. Exemplary metal wood golf clubs are disclosed in U.S. Pat. No. 5,873,791, which is incorporated herein by reference.

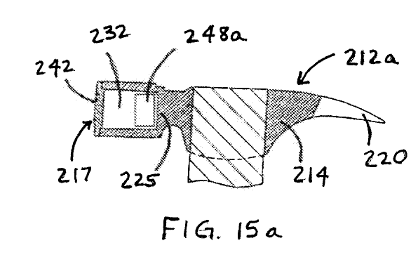

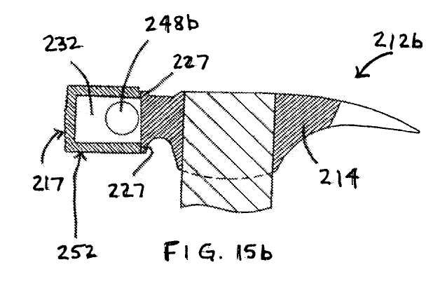

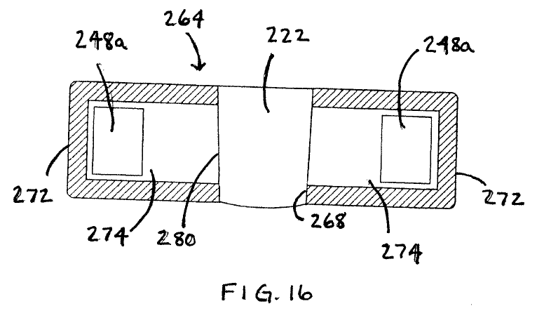

FIGS. 14a and 14b show an exemplary hammer 200 provided in accordance with aspects of the present invention. The hammer 200 comprises a hammer head 212 and a handle 222. The hammer head 212 includes a body 214, a claw 220, a hollow chamber 232 defined by an impact body section 250, and an impact plate 217 having an impact surface 218. The handle 222 has a grip 230 and fits into the opening 226 in the hammer head 212. As shown, the handle chamber for receiving the handle 222 has a single opening 226. However, in other embodiments, such as that shown in FIG. 15a, the handle chamber has two openings for manipulating the handle to be retained therein, such as for inserting a wedge to retain the handle to the hammer head.

In a preferred embodiment, the hammer 200 has a single insert element 248 disposed in the hollow chamber 232. In the embodiment shown in FIG. 14a, the insert element 248a is cylindrical in shape. In other embodiments, the insert element may be other shapes, such as the spherical insert element 248b shown in FIG. 14b. In FIGS. 14a and 14b, the hollow chamber 232 is cylindrical in shape, and therefore a spherical or cylindrical insert element 248a or 248b is preferred. The cylindrical or spherical insert element can move freely inside the cylindrical hollow chamber 232 without becoming obstructed or deflected by the inside surface of the chamber. For example, when the hammer is swung, the insert element can freely translate and rotate, either at least some or a full 360 degrees, within the chamber. In other embodiments, the chamber may have a different shape, such as a square cross-section, in which case an insert element with a corresponding cross-section may be more preferred.

The insert element 248a may be formed of steel, tungsten, or another suitable metal or high-density material. The weight of the insert element is about 25% to about 70% of the weight of the hammer head 212, with about 30% to about 60% being more preferred. The insert element 248a has a diameter or width that is about 50-95%, and preferably about 70-90%, of the inside diameter or width of the chamber 232. This relative sizing allows the insert element 248 to carry a large amount of mass without being so large that it rubs or chafes against the inside surface of the chamber when the insert element moves. Thus, the insert element 248 can move back and forth freely within the chamber, but it is still large enough to provide an anti-recoil effect when the hammer 200 is swung. To maximize the mass of the insert element without making it too large to move freely, a solid insert element is preferred.

The length of the insert element and the chamber may be adjusted according to many variables, including the desired amount of anti-recoil force, the desired amount of recoil the hammer experiences before the anti-recoil force occurs, the mass of the insert element, and the size and shape of the chamber 232. In the embodiment shown in FIG. 14a, the insert element has a length that is approximately half of the inside length of the chamber 232. The other half of the chamber length provides a space for the insert element 248 to travel to and fro when the hammer is swung and the insert element moves to cancel or minimize the recoil. Said differently, the insert element is configured to move across the chamber 232 to impact the impact plate 217 after the hammer 200 has been struck against a work surface. The delay between the hammer's impact and the insert element's impact provides the anti-recoil effect. The empty space left in the chamber 232 allows the insert element to impact the impact plate 217 with a delay. In other embodiments, the insert element may have a length that is less than or more than half of the length of the chamber 232.

The single insert element may offer advantages over prior art deadblow hammers comprising a plurality of smaller insert elements. The single insert element 248a or 248b moves as a whole in one direction when the hammer 200 is swung. The interior surface of the chamber 232 guides the movement of the insert element 248a towards the impact plate 217 when the hammer impacts a work surface. Because the insert element 248a or 248b is a unitary construction body, all of its mass moves toward and impacts the impact plate 217. When a plurality of insert elements are placed in the chamber, individual elements may be scattered or deflected in transverse directions when the hammer is used. Thus, when such a hammer impacts a work surface, individual impact elements may scatter against each other and cancel out their anti-recoil effect and consequently less than all of the mass inside the chamber moves directly toward and impacts the impact plate 217. However, when only a single insert element is used, such as that shown in FIGS. 14a and 14b, all of the mass of the insert element moves in the same direction. This single solid insert element embodiment has been tested and the results have shown a more direct and efficient anti-recoil effect.

In the embodiment shown in FIGS. 14a and 14b, the chamber 232 is integral with the hammer head 212 and is opened all the way to the handle 222. In other embodiments, the chamber is enclosed and is not opened to the handle (see, for example, FIGS. 15a and 15b). In FIGS. 14a and 14b, the insert element 248a or 248b may be placed inside the chamber through the opening 242 at the front end of the impact body section 250. The impact plate 217 is then welded or otherwise attached to the end surface 244 of the chamber 232 to close the opening 242.

FIG. 15a shows another exemplary embodiment of a hammer head 212a provided in accordance with practice of the present invention. In this embodiment, the chamber 232 does not open all the way to the handle 222, but closes off at its end 225. The chamber 232 is integral with the hammer head 212a and may be made by casting, forging, machining, or a combination thereof. The insert element 248a is placed into the chamber 232 through the opening 242, and then the impact plate 217 is welded or otherwise attached to the chamber to close the opening.

FIG. 15b shows another embodiment of a hammer head 212b in accordance with practice of the present invention. In this embodiment, a cylindrical impact body section 252 defining a chamber 232 is formed separately from the body 214 of the hammer head 212b. The impact plate 217 is integrally formed to the cylindrical impact body section 252. The insert element 248b is placed inside the chamber 232 and the cylindrical impact body section 252 is then welded or otherwise attached to the front end surface 227 of the body 214, thereby sealing the chamber with the insert element 248b inside. In one exemplary embodiment, the impact body section 162 is welded to the body 214. In another embodiment, the impact body section 252 is welded to the body 214 using inertia welding.

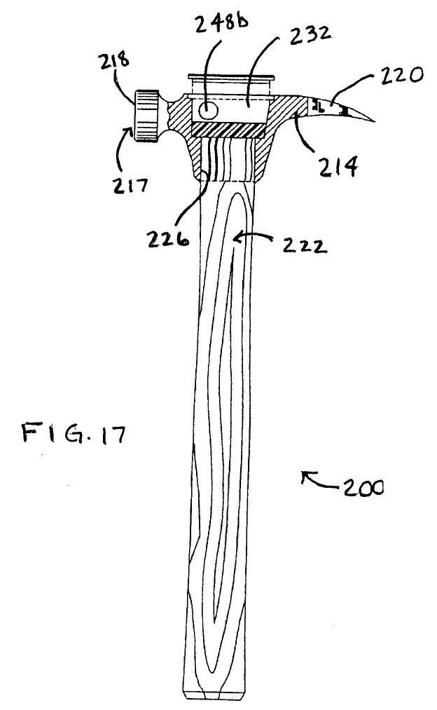

FIG. 16 shows an alternative hammer head 264 provided in accordance with practice of the present invention. The hammer head 264 is commonly found in a sledge hammer. The hammer head 264 comprises two hollow chambers 274, two insert elements 248a, and two impact surfaces 272. A handle 222 is provided in the middle between these pairs of elements. In this embodiment, the chambers 274 and impact plates 272 are integrally formed from a one piece material, with an opening or handle chamber 280 in between them for accommodating the handle 222. The insert elements 248a are placed in their respective chambers, and the handle 222 is inserted into the chamber 280 to seal the two insert element chambers 274. In other embodiments, the chambers 274 may be formed separately from the impact plates 272, and the chambers 274 may or may not open to the handle 222. The insert elements 248a may be placed into the chambers 274, and then the impact surfaces 272 may be welded or otherwise attached to the hammer head 264 to seal the chambers.

FIG. 17 shows an exemplary deadblow hammer 200′, which is described in greater detail in U.S. Pat. No. 6,311,582 B1 to Chow, which is expressly incorporated herein by reference. This embodiment shows a single solid insert element 248b incorporated in the hammer head as an improvement over the prior art. The insert element 248b is spherical in shape, and the chamber 232 is cylindrical. The insert element 248b moves freely and unimpeded through the chamber 232 when the hammer 200 is swung. The size of the insert element relative to the size of the chamber 232 is preferably the same as discussed above with reference to FIGS. 14a and 14b. In this embodiment, the chamber 232 is not integrally formed with the hammer head 212 but is inserted into the hammer head above the handle 222.

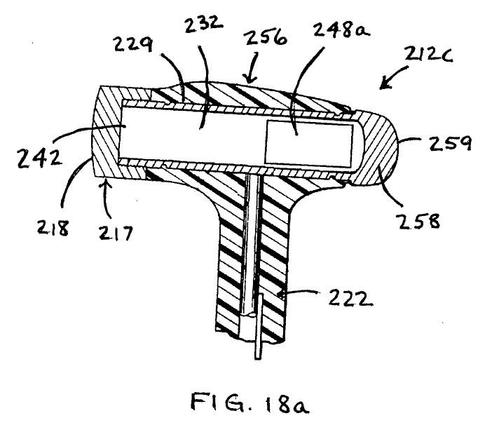

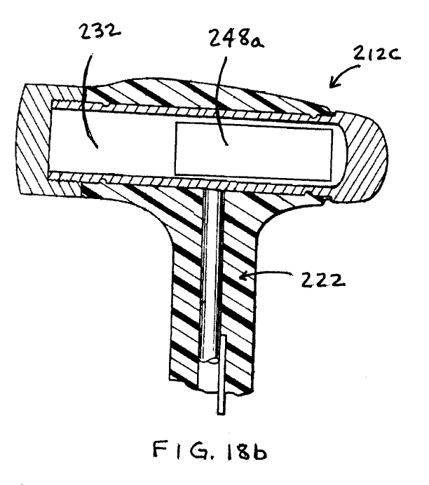

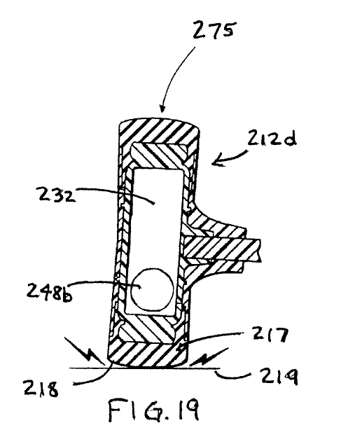

FIGS. 18a and 18b show an exemplary hammer head 212c, which is described in greater detail in U.S. Pat. No. 4,039,012 to Cook, which is expressly incorporated herein by reference. This embodiment shows a single solid insert element 248a as an improvement over the prior art. In this embodiment, the hammer head 212c is formed from multiple different components, one of which, the outer body 256, is integral with the handle 222. The hammer head 212c includes a central bore 229 into which an inner body 258 having a chamber 232 and an integrally formed end piece 259 is placed. The impact plate 217 is threadedly attached, or alternatively welded, at the front of the inner body 258 to close the opening 242 of the chamber 232 and seal the insert element 248a inside. The insert element 248a and the chamber 232 are cylindrical in shape, although a spherical insert element 248b may be used as well. In FIG. 18a, the insert element 248a has a length that is less than half the length of the chamber 232, while in FIG. 18b the insert element 248a has a length that is greater than half the length of the chamber 232. The relative lengths of the chamber and insert element may be varied as described above, depending on the desired anti-recoil effect.

FIG. 19 shows an exemplary hammer head 212d, which is described in greater detail in U.S. Pat. No. 6,052,885 to Carmien, which is expressly incorporated herein by reference. This embodiment shows a single solid insert element 248b as an improvement over the prior art. In this embodiment, the hammer head 212d is formed around the chamber 232. The hammer head 212d is shown as it impacts a work surface 219. The insert element 248b moves through the chamber 232 to strike the impact plate 217 when the hammer impacts the work surface 219. The arrow 275 shows the motion of the hammer head 212d. As described above, the single insert element 248b moves with all of its mass directly toward the impact plate 217 to provide the desired anti-recoil effect.

Although the preferred embodiments of the invention have been described with some specificity, the description and drawings set forth herein are not intended to be delimiting, and persons of ordinary skill in the art will understand that various modifications may be made to the embodiments discussed herein without departing from the scope of the invention, and all such changes and modifications are intended to be encompassed within the appended claims. Various changes to the hammer head and golf club head may be made including changing the contour, the weight, the hollow chamber configuration, the overall dimensions, incorporating certain aspects of one embodiment into another embodiment provided they are compatible, etc. As another example, rather than a single cylindrical insert element (e.g., FIG. 18a) or a single spherical insert element (e.g., FIG. 19), two or more back-to-back cylindrical insert elements or spherical insert elements may be used so long as their relative positions are aligned to minimize deflection upon impact, which would diminish the recoil canceling force discussed above in connection with using a plurality of insert elements. Accordingly, many alterations and modifications may be made by those having ordinary skill in the art without deviating from the spirit and scope of the invention.

What is claimed is:

1. A deadblow hammer comprising:
a hammer head comprising a body section having an interior surface defining an anti-recoil chamber having an internal cross-sectional dimension, the hammer head further comprising a handle chamber, an impact surface, a front wall disposed opposite the impact surface, and at least one of a back wall opposite the front wall and an opening in communication with the handle chamber;
an insert element disposed within the anti-recoil chamber and in contact with the interior surface of the body section; and
a handle attached to the handle chamber;
wherein the insert element has a width that is about 50 percent to about 95 percent of the internal cross-sectional dimension of the anti-recoil chamber and wherein the insert element is movable within the anti-recoil chamber and contacts both the front wall and at least one of the back wall and the handle.

2. The deadblow hammer of claim 1, wherein the width of the insert element is about 70 percent to about 90 percent of the internal cross-sectional dimension of the anti-recoil chamber.

3. The deadblow hammer of claim 1, wherein the anti-recoil chamber has a circular cross section.

4. The deadblow hammer of claim 3, wherein the insert element is cylindrical.

5. The deadblow hammer of claim 3, wherein the insert element is spherical.

6. The deadblow hammer of claim 1, wherein the insert element has a length that is about half of the length of the anti-recoil chamber.

7. The deadblow hammer of claim 1 wherein the insert element is rotatable and translatable within the anti-recoil chamber.

8. The deadblow hammer of claim 1, wherein the handle chamber comprises top and bottom ends, and wherein the handle is configured to extend through the handle chamber such that the handle is visible from the ends of the handle chamber.

9. The deadblow hammer of claim 1, wherein the impact surface comprises a plurality of bumps.

10. The deadblow hammer of claim 1, further comprising a second anti-recoil chamber located opposite the handle from the first anti-recoil chamber, a second impact surface attached to the second anti-recoil chamber, and a second insert element disposed inside the second anti-recoil chamber.

11. The deadblow hammer of claim 1, wherein the insert element comprises a steel pellet.

12. The deadblow hammer of claim 1, wherein the hammer head has a weight and wherein the insert element has a weight of about 30 percent to about 70 percent of the weight of the hammer head.

13. A deadblow hammer comprising:
a hammer head comprising an impact surface and a body section having an interior surface defining an anti-recoil chamber having an internal width, the interior surface having an opening;
a handle attached to the hammer head;
an insert element placed in the anti-recoil chamber by way of the opening, the insert element having a width that is greater than half the internal width of the anti-recoil chamber, wherein the insert element is movable within the anti-recoil chamber and contacts the interior surface of the body section;
wherein the opening is adapted to be closed after placement of the insert element;
wherein the anti-recoil chamber is defined by a front wall disposed opposite the impact surface, the interior surface of the body section, and at least one of a portion of the handle and a back wall opposite the front wall; and
wherein the insert element is adapted to contact at least one of the portion of the handle and the back wall when the hammer is swung forward.

14. The deadblow hammer of claim 13, wherein the opening is sealed by the impact surface.

15. The deadblow hammer of claim 13, wherein the opening is adapted to be closed by attaching the body section to the hammer head.

16. The deadblow hammer of claim 13, wherein the opening is configured to be closed by attaching the handle to the hammer head.

17. The deadblow hammer of claim 13 wherein the insert element is rotatable and translatable within the anti-recoil chamber.

18. The deadblow hammer of claim 13 wherein the insert element can move freely inside the anti-recoil chamber and is constrained only by the front wall, the interior surface, and at least one of the portion of the handle and the back wall.

19. A deadblow hammer comprising:
a hammer head comprising an anti-recoil chamber having an internal cross-sectional dimension, the hammer head further comprising a handle chamber, an impact surface, a front wall disposed opposite the impact surface, and at least one of a back wall opposing the front wall and an opening in communication with the handle chamber;
an insert element disposed within the anti-recoil chamber; and
a handle attached to the handle chamber;
wherein the insert element has a width that is about 50 percent to about 95 percent of the internal cross-sectional dimension of the anti-recoil chamber and wherein the insert element is rotatable and translatable within the anti-recoil chamber and contacts both the front wall and at least one of the back wall and the handle.

20. The deadblow hammer of claim 19 wherein the handle has two exposed ends.
